(19) United States
(12) Patent Application Publication
(10) Pub. No.: US 2008/0186223 A1
(43) Pub. Date: Aug. 7, 2008

(54) Radar Sensor for Motor Vehicles

(75) Inventors: Hermann Mayer, Vaihingen (DE); Bernhard Lucas, Besigheim (DE); Joerg Hilsebecher, Hildesheim (DE); Joachim Hauk, Renningen-Malmsheim (DE); Paco Haffmans, Boeblingen (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 11/663,369

(22) PCT Filed: Jul. 11, 2005
(86) PCT No.: PCT/EP05/53310

§ 371 Date: Apr. 4, 2008

(30) Foreign Application Priority Data
Sep. 29, 2004 (DE) 10 2004 047 086.3

(51) Int. Cl. G01S 13/58

(52) U.S. Cl. 342/109

(57) ABSTRACT

A radar sensor for motor vehicles, including at least one transmitter and receiver device for transmitting and receiving a frequency-modulated radar signal, an analyzer unit for computing the distances and relative velocities of the located objects, and an integrated Doppler radar system for independent measurement of the relative velocities.

### FIELD OF THE INVENTION

The present invention relates to a radar sensor for motor vehicles, including at least one transmitter and receiver device for transmitting and receiving a frequency-modulated radar signal and an analyzer unit for computing the distances and relative velocities of the located objects.

### BACKGROUND INFORMATION

Such radar sensors are frequently used in motor vehicles in a driver assistance system, such as an ACC system (adaptive cruise control), for automatic radar-assisted distance control.

A typical example of a radar sensor of the type mentioned above is an FMCW radar (frequency modulated continuous wave), where the frequency of the transmitted radar signal is periodically modulated with a specific ramp slope. The frequency of a signal that has been reflected by a radar target and is then received by the radar antenna at a certain point in time therefore differs from the frequency of the signal that is transmitted at this point in time by an amount which is dependent, on the one hand, on the signal propagation time and, thus, on the distance of the radar target and, on the other hand, on the Doppler shift and, thus, on the relative velocity of the radar target. In the radar sensor, the received signal is mixed with the signal transmitted at this point in time. The mixed product so obtained is a low-frequency signal, whose frequency corresponds to the difference in frequency between the transmitted and the received signal. This low-frequency signal is then digitized in the analog-to-digital converter with a suitable time resolution. The digitized data is recorded during a certain recording period, which corresponds, for example, to the length of the ramp with which the transmitted signal is modulated. The data set so obtained is then transformed into a spectrum using an algorithm known as the “fast Fourier transform” (FFT). In this spectrum, each detected radar target is represented by a peak, which stands out, more or less distinctly, from the background noise level. By repeating this procedure using different ramp slopes, it is possible to eliminate the ambiguity between the propagation time-dependent frequency shift and the Doppler shift, thus allowing computation of the distance and relative velocity of the radar target.

In motor vehicles, it is usual to use an angular-resolution radar sensor, which generates a plurality of radar lobes that are slightly angularly offset from each other, and the above-described signal processing and analysis is then performed separately for each individual radar lobe, preferably in parallel channels.

For traffic safety reasons, the radar sensor should allow other vehicles and obstacles to be located as reliably as possible. Furthermore, efforts are being made to enhance the functionality of driver assistance systems with the long-term objective being to provide fully autonomous vehicle control. As new and increasingly more complex functions are added to the driver assistance system, the level of reliability required of the radar sensor increases correspondingly.

### SUMMARY OF THE INVENTION

The present invention has the advantage of increasing the reliability of the radar sensor. To this end, in accordance with the present invention, the radar sensor has an integrated Doppler radar, which allows the relative velocities of the located objects to be measured independently. In this manner, the redundancy of the system is increased, and, by matching the relative velocities measured by the Doppler radar to the relative velocities computed by the analyzer unit based on the frequency-modulated signal, any errors in the transmitter and receiver device and/or in the analyzer unit can be quickly detected, so that suitable countermeasures can be initiated. In addition, the present invention makes it easier to eliminate ambiguities, especially when locating several objects simultaneously. During analysis of the spectra obtained using the frequency-modulated signal, misinterpretations, which can easily occur, especially in the case of very noisy signals, can therefore be quickly and reliably detected and corrected.

A particularly simple and inexpensive design of the redundant radar sensor can be achieved by using essentially the same components for the Doppler radar system as those already present in the frequency-modulated radar system, for example, an FMCW radar.

In order to generate the radar signal for the Doppler radar, preferably, a reference oscillator is used, which, at the same time, is used to control the frequency during the generation of the frequency-modulated signal.

In a particularly preferred embodiment, the reference oscillator is formed by a dielectric resonator (DRO) operating at a frequency whose integral multiple is near the operating frequency band of the oscillator used to generate the frequency-modulated signal. For example, if the operating frequency band is from about 76 to 77 GHz, then the reference oscillator has a frequency of, for example, 12.65 GHz, 19 GHz or 24.5 GHz, which is equivalent to one-sixth, one-fourth or one-third of the mid-frequency of the operating frequency band, respectively. For frequency control purposes, the harmonic of the reference oscillator near the operating frequency band is fed to a harmonic mixer and mixed with the frequency-modulated signal. The mixed product is then equivalent to the difference between the modulated frequency and the fixed reference frequency (of the harmonic), and is used as a feedback signal for frequency control, for example, in a phase locked loop (PLL).

The fundamental frequency of the reference oscillator is used directly as the transmitting frequency for the operation of the Doppler radar. In this embodiment, therefore, there is no need to provide a special oscillator for the Doppler radar. Another advantage is that the frequency of the Doppler radar is only a fraction of the frequency of the FMCW radar, so that interference, such as noise signals, rain or snow, and the like, have different effects on the two radar systems and, therefore, interferences in one system can be detected and, if necessary, compensated for by the other system.

In a typical design of an angular-resolution radar sensor, the antenna has a plurality of antenna elements (patches) disposed in the focal plane of a lens in laterally offset relation to each other, so that the radar lobes generated by the individual patches and converged by the lens are angularly offset from each other. Preferably, the same lens is used for the Doppler radar, an additional patch being disposed in the focal plane, or slightly offset therefrom, said additional patch being connected to the reference oscillator and matched to the frequency thereof. Due to stronger diffraction effects at the lower frequency of the reference oscillator, the radar lobe generated by the additional patch is less strongly converged, so that an additional angular range can be covered by the one additional patch. Additional beam expansion can be achieved, if desired, by disposing this patch slightly out of focus.

The radar sensor repeats the radar measurements periodically, typically with a period on the order of 100 ms. However, the plurality of frequency ramps with which the signal of the FMCW radar is modulated altogether make up only a fraction of this period, for example about 15 ms. During the remaining time, which is needed, for example, for signal analysis, no frequency control is required, so that the reference oscillator can be used as a signal source for the Doppler radar during this time period.

For signal analysis purposes, it is also possible to use essentially components that are already present. Usually, each antenna patch used for generating the angularly offset, frequency-modulated radar beams has a separate preamplifier associated therewith, which amplifies the low-frequency signal (intermediate frequency signal) of the corresponding mixer. The additional patch provided for the Doppler radar has a separate mixer associated therewith. However, to amplify the intermediate frequency signal produced by this mixer, one of the other preamplifiers can be used during the operation of the Doppler radar. Similarly, the already present hardware can be used to transform the intermediate frequency signal of the Doppler radar into a spectrum by fast Fourier transform. In this process, it is only necessary to adapt the parameters of the transformation algorithm with respect to the smaller frequency of the Doppler radar. However, in order to add redundancy to the system, it is also possible to use a separate processor to compute the spectrum for the Doppler radar.

The downstream analysis software simply needs to be enhanced with a module which computes the relative velocities of the located objects from the spectrum of the Doppler radar and compares them to the relative velocities determined by the FMCW radar. When the radar sensor operates without error, the independently determined relative velocities must be consistently correlatable with each other. If this is not possible, then an error exists in the system. In the simplest case, the system is then shut down or restarted, and a warning is issued to the driver. If the error cannot be corrected by a restart, the system is completely shut down, and the driver is suitably prompted to go to a garage.

However, in a further embodiment of the present invention, the relative velocities independently determined by the Doppler radar can also used to automatically correct errors of the FMCW radar and/or to eliminate ambiguities in the results of the FMCW radar, which would otherwise not be able to be removed.

### BRIEF DESCRIPTION OF THE DRAWINGS

FIG. 1 is a block diagram of a radar sensor according to the present invention.

FIG. 2 is a frequency/time diagram for illustrating the operation of the radar sensor of FIG. 1.

FIG. 3 is a distance/velocity diagram for illustrating a method for analyzing the measurement results.

### DETAILED DESCRIPTION

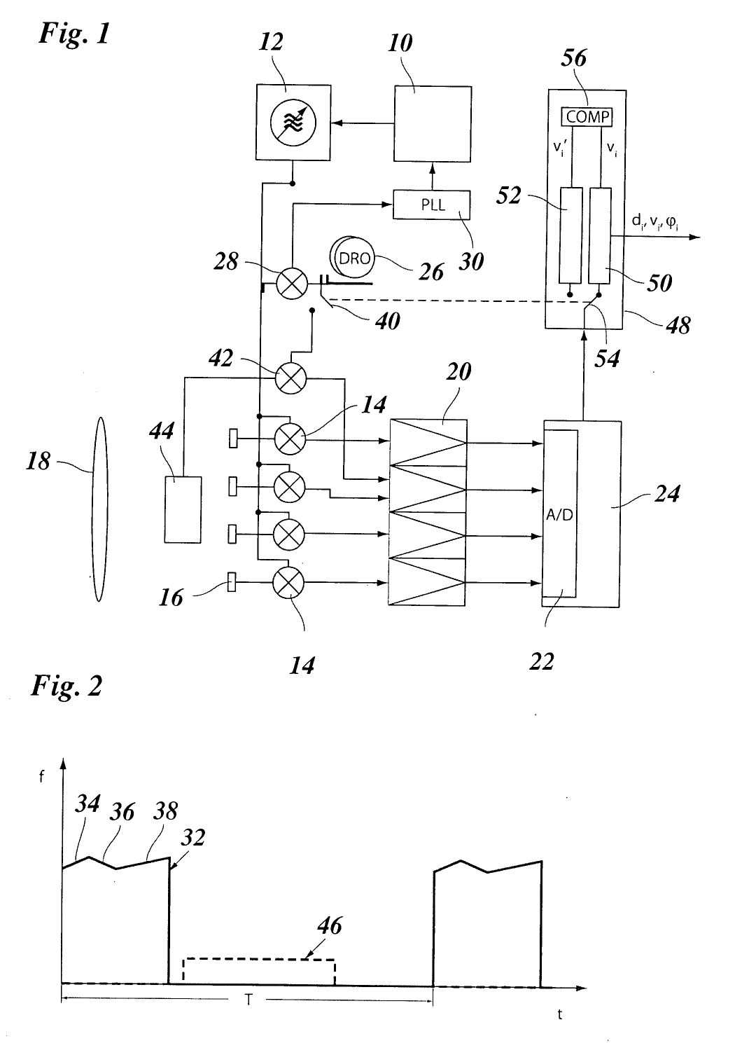

The radar sensor shown in FIG. 1 includes an oscillator driver 10 which, using a voltage signal, controls the oscillation frequency of a controllable oscillator 12. The frequency of oscillator 12 so controlled is in an operating frequency band from about 76 to 77 GHz. The output signal of oscillator 12 is supplied to a plurality, in the example shown four, of mixers 14, which are each connected to an antenna patch 16. Antenna patches 16, to which the signal of oscillator 12 is supplied via mixers 14, are disposed in the focal plane of a lens 18 in laterally offset relation to each other, so that the radar radiation emitted from the patches is converged into four beams that are slightly angularly offset from each other. When one of these beams hits a radar target, then the reflected signal is focused through lens 18 back onto the antenna patch 16 from which the beam was emitted. The received signal then returns to mixer 14, where it is mixed with the signal that is supplied to the mixer from oscillator 12 at this point in time. The mixed product so obtained is an intermediate frequency signal whose frequency (on the order of about 100 kHz) corresponds to the difference in frequency between the received signal and the signal of oscillator 12. The intermediate frequency signals of the four mixers 14 are amplified in a four-channel preamplifier 20, digitized in an analog-to-digital converter 22, and then transformed into spectra in a first processor 24 by fast Fourier transform (FFT).

The frequency of oscillator 12 is modulated in a ramped form by means of an oscillator driver 10, and controlled in a closed loop during this process. For frequency control purposes, a reference oscillator 26 is used, for example a dielectric resonator (DRO), whose frequency is, for example, one-third of the mid-frequency of the operating frequency band of oscillator 12, which, in the example under discussion, is therefore about 24.5 GHz. The third harmonic of the frequency of the reference oscillator 26 is fed to a harmonic mixer 28, where it is mixed with the signal of oscillator 12. The mixed product, which thus indicates the difference between the instantaneous frequency of oscillator 12 and the fixed frequency of reference oscillator 26, is fed back via a phase locked loop (PLL) 30 to oscillator driver 10, and thus serves as a feedback signal for frequency control.

In FIG. 2, the graph 32 drawn with bold solid lines indicates the frequency f of oscillator 12 as a function of time t. A complete measuring cycle of the radar sensor has the period T. At the start of this measuring cycle, oscillator 12 is active and its frequency is modulated, for example, with a rising ramp 34, which is followed by a falling ramp 36, whose slope can be of the same magnitude as ramp 34. Then, a further rising ramp 38 follows, whose slope is, for example, only half the slope of ramp 34. After that, oscillator 12 is inactive for the rest of the measuring cycle, so that reference oscillator 26 is no longer needed for frequency control. Using a switch 40 (such as a PIN diode switch or a MEM switch), reference oscillator 26 is then connected to a further mixer 42, via which the fundamental frequency of the reference oscillator is transmitted to an additional antenna patch 44 disposed on the optical axis of lens 18. Antenna patch 44 is larger than antenna patches 16 because it transmits a radar signal of greater wavelength, according to the fundamental frequency of reference oscillator 26. As symbolically indicated in FIG. 1, antenna patch 44 may be disposed at a position slightly before the focal plane of lens 18, so that the radar beam generated by this patch diverges more strongly. This radar beam, whose frequency is not modulated, allows the relative velocities of the objects located by it to be measured according to the principle of a Doppler radar.

Here too, the radar echo is focused through lens 18 back onto antenna patch 44, and the received signal is mixed in mixer 42 with the signal of reference oscillator 26. The mixed product is supplied to one of the four channels of preamplifier 20, preferably to a channel belonging to an antenna patch 16 whose radar lobe deviates only slightly from the optical axis of lens 18. The preamplified intermediate frequency signal of mixer 42 is then digitized and transformed into a spectrum in the same manner as was done before with the signals of mixers 14.

In FIG. 2, the graph 46 drawn with dashed lines shows the frequency of the signal transmitted by antenna patch 44 as a function of time. It can be seen that the signals of antenna patches 16, one the one hand (graph 32), and of antenna patch 44, on the other hand, are offset in time. Therefore, when the intermediate frequency signal of mixer 42 is to be amplified and analyzed, preamplifier 20, analog-to-digital converter 22, and first processor 24 are not busy with analyzing the signals from antenna patches 16.

Therefore, the radar sensor described integrates the functions of an angular-resolution FMCW radar (antenna patches 16) and of a Doppler radar, which does not provide angular resolution (antenna patch 44). In the example shown, the spectra computed by processor 24 for both sub-systems are further analyzed in a second processor 48. In each measuring cycle, three spectra, which are recorded during the three ramps 34, 36 and 38, are obtained in each of the four channels of the FMCW radar. Each radar target detected in the particular channel appears in this spectrum in the form of a peak at a frequency which is dependent on both the distance and the relative velocity of the radar target. A module 50 of processor 48 computes therefrom the distances dᵢ and relative velocities vᵢ of the located radar targets, as will be explained in greater detail hereinafter.

Moreover, since generally each radar target is detected by several of the four radar beams, it is also possible to compute the azimuth angle φᵢ of the objects by comparing the amplitude and/or phase relation between the different channels in module 50.

When, after closing switch 40, the Doppler radar is active and the corresponding spectrum has been computed in processor 24, this spectrum is analyzed in another module 52 of second processor 48. This is symbolized in FIG. 1 by a switch 54 coupled to switch 40, although in practice, module 52 will be a software module which is only invoked when the computation of the spectrum is complete. In the spectrum recorded by the Doppler radar too, each of the located objects appears as a peak at a characteristic frequency, and an independent value vᵢ′ for the relative velocity of the object can be computed from this frequency.

Assuming that the Doppler radar detects all objects detected by the four radar beams of the FMCW radar together, there must be a substantially identical value vᵢ′ for each value vᵢ computed by module 50. This is checked in second processor 48, as symbolized by a comparator module 56 in FIG. 1.

A failure of the independently determined relative velocities to match suggests a malfunction of the radar sensor. Such a malfunction can be a transient failure, which may be that one of the objects detected by the angular-resolution FMCW radar is located outside the detection range of the Doppler radar, or vice versa. Such errors can be ignored if they occur only sporadically. However, an increase in cases where the Doppler radar locates more objects than the FMCW radar suggests partial blindness of the FMCW radar, and a warning should be issued to the driver. Similarly, a breakdown or malfunction of one of mixers 14 may also be detected.

Since the data of the FMCW radar and of the Doppler radar are digitized in analog-to-digital converter 22, sporadically occurring digitization errors due to interference signals or the like will also manifest themselves in comparator module 56. Since the algorithm for the fast Fourier transform in the Doppler radar system works with other parameters than in the FMCW radar system, any errors in the computation of the spectra generally will generally also become apparent.

Finally, errors may also occur in the computation of the distances and relative velocities in module 50, especially when the signal quality is poor. Such errors can occur especially when the peaks present in the different spectra are not correctly associated with the real objects. This causes errors in the computed distances and azimuth angles as well as in the computed relative velocities. Such errors can therefore also be detected in comparator module 56 and immediately corrected if necessary.

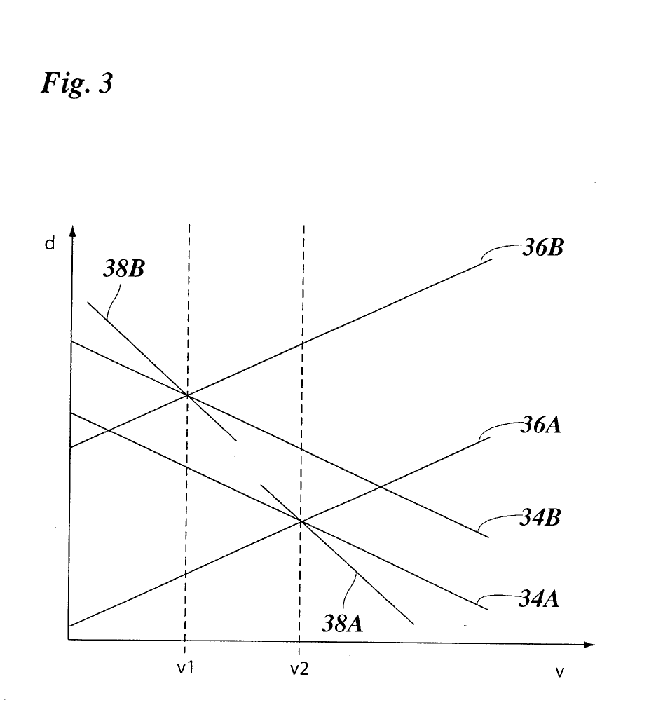

This is explained in greater detail below with reference to FIG. 3. For the sake of simplicity, only one of the four channels of the FMCW radar is discussed and, furthermore, it is assumed that exactly two radar targets are being located in this channel. Therefore, the three spectra recorded for the three ramps 34, 36, 38 each contain two peaks at different frequencies. However, it is not clear from the outset, which peak belongs to which object.

The mid-frequency of each peak, however, defines a relationship between distance d and relative velocity v of the object in question. In the diagram of FIG. 3, this relationship can be represented by a straight line. For the spectra recorded during rising ramp 34, falling straight lines 34A and 34B are obtained, respectively, since the distance- and frequency-dependent components of the frequency shift add together. Therefore, the higher the relative velocity, the smaller must be the distance. For falling ramp 36, rising straight lines 36A, 36B are obtained accordingly. These four straight lines intersect in four points, and the pair of values (v, d) belonging to each of these four points is a candidate for a real object. However, since only two real objects are present, the ambiguity is only eliminated when adding two additional straight lines 38A, 38B, which result from ramp 38. These are falling straight lines again, but they are steeper because the slope of ramp 38 is smaller. Ideally, three straight lines 34A, 36A, 38A and 34B, 36B, 38B, respectively, intersect in one point, which then indicates the distance and relative velocity of a real object. In this manner, relative velocities v1 and v2 are obtained for the two objects with the aid of module 50.

If the system operates properly, the same relative velocities v1 and v2 must be obtained by module 52, as is symbolized in FIG. 3 by dashed vertical lines.

In reality, because of measuring errors, the three straight lines, for example, 34A, 36A and 38A, belonging to the same object often do not meet exactly in one point. Therefore, in some circumstances, it may be difficult to decide which point should be taken as the intersection point of the straight lines. Using the additional information obtained with the aid of the Doppler radar and module 52 makes this decision much easier.

1-8. (canceled)

9. A radar sensor for a motor vehicle, comprising:
at least one transmitter and receiver device for transmitting and receiving a frequency-modulated radar signal;
an analyzer unit for computing distances and relative velocities of located objects; and
an integrated Doppler radar system for independent measurement of the relative velocities.

10. The radar sensor according to claim 9, wherein a reference oscillator for controlling a frequency of the frequency-modulated radar signal at the same time constitutes an oscillator of the Doppler radar system.

11. The radar sensor according to claim 10, wherein the frequency-modulated radar signal is in an operating frequency band which corresponds to an integral multiple of the frequency of the reference oscillator.

12. The radar sensor according to claim 10, wherein the radar sensor is designed to cyclically repeat radar measurements and to generate the frequency-modulated radar signal during each measuring cycle only during part of a period of the measuring cycle, and further comprising a switch to connect the reference oscillator to the transmitter and receiver device for the Doppler radar during a time in which the frequency-modulated radar signal is not generated.

13. The radar sensor according to claim 9, wherein the transmitter and receiver device includes at least one antenna patch for emitting the frequency-modulated radar signal, and a separate antenna patch is provided for the Doppler radar system.

14. The radar sensor according to claim 13, wherein the at least one antenna patch for the frequency-modulated radar signal and the separate antenna patch of the Doppler radar system are mounted in front of a common lens.

15. The radar sensor according to claim 13, further comprising:
at least one mixer for mixing the received signal with the transmitted signal associated respectively with the at least one antenna patch for the frequency-modulated radar signal;
a preamplifier connected to intermediate frequency outputs of the mixer, the preamplifier having as many channels as there are mixers for the frequency-modulated radar signal; and
a further mixer associated with the antenna patch for the Doppler radar system, an intermediate frequency output of the further mixer being connected to one of the channels of the preamplifier.

16. The radar sensor according to claim 9, wherein the analyzer unit includes a first module for computing the distances and relative velocities of the objects based on the frequency-modulated radar signal, a second module for computing the relative velocities of the objects based on the Doppler radar system, and a comparator module for comparing the relative velocities computed by the first and second modules.
